(19) United States
(12) Patent Application Publication
(10) Pub. No.: US 2026/0227815 A1
(43) Pub. Date: Aug. 6, 2026

(54) WIDE-SWING INTRINSIC MOSFET CASCODE CURRENT MIRROR

(71) Applicant: pSemi Corporation, San Diego, CA (US)

(72) Inventor: Rogelio CICILI, San Diego, CA (US)

(21) Appl. No.: 19/149,813

(22) PCT Filed: Jan. 25, 2024
(86) PCT No.: PCT/US24/12886

§ 371 Date: Jul. 21, 2025

Related U.S. Application Data
(63) Continuation of application No. 18/160,536, filed on Jan. 27, 2023, now Pat. No. 11,966,247.

(51) Int. Cl. G05F 3/26; G05F 3/20

(52) U.S. Cl. CPC G05F 3/262; G05F 3/205

(57) ABSTRACT

Methods and devices for a wide-swing cascode current mirror with low headroom voltage and high output impedance are presented. An input leg of the current mirror includes a composite transistor in series connection with an intrinsic transistor. The composite transistor includes two series-connected regular transistors with respective sizes that are twice the size of the intrinsic transistor. An output leg of the current mirror includes a regular transistor in series connection with an intrinsic transistor. A gate voltage of the composite transistor, provided at a node that is common to gates of the two series-connected regular transistors, self-establishes when a reference current flows through the input leg. The self-established gate voltage is used to bias the regular transistor of the output leg. Biasing voltages to gates of the intrinsic transistors is provided by an intermediate node that provides the series connection of the regular transistors of the composite transistor.

### CROSS-REFERENCE TO RELATED APPLICATIONS

The present application claims priority to and the benefit of co-pending U.S. application Ser. No. 18/160,536 entitled “Wide-Swing Intrinsic MOSFET Cascode Current Mirror”, filed on Jan. 27, 2023, the disclosure of which is incorporated herein by reference in its entirety.

### TECHNICAL FIELD

The present disclosure is related to electronic circuits, and more particularly to cascode current mirrors having low headroom voltage and high output impedance to enable a wide-swing output voltage.

### BACKGROUND

With the advent of nanometer scale technologies (i.e., <90 nm), electronic circuits may need to operate at low voltages (e.g., <1.2 volts) due to the lower breakdown voltages of transistors fabricated according to such nanometer scale technologies. Accordingly, analog signal processing may benefit from current-mode, instead of voltage-mode, approaches due to a lower headroom voltage made available by the low voltages of operation. It is therefore expected that current mirrors will take a more important role in current-mode signal processing.

Transistors fabricated according to nanometer scale technologies may however suffer from lower output resistances due to short-channel effects. When used in (an output leg of) a current mirror, a transistor with a lower output resistance may degrade performance of the current mirror and deviate from operation as an ideal current source (e.g., a current source with infinite output/internal resistance).

The above prior art shortcomings are a basis for the teachings according to the present disclosure, including a practical and scalable cascode current mirror with a reduced headroom voltage for a wide-swing output voltage.

### SUMMARY

According to a first aspect of the present disclosure, a cascode current mirror circuit is presented, comprising: an input leg comprising a common-source composite transistor in series connection with a first common-gate intrinsic transistor; and an output leg comprising a first common-source transistor in series connection with a second common-gate intrinsic transistor, wherein the composite transistor comprises two series-connected transistors with gates connected at a gate node of the common-source composite transistor, and an intermediate node that connects the two series-connected transistors is connected to gates of the first and second common-gate intrinsic transistors.

According to a second aspect of the present disclosure, a method for operating a cascode current mirror with low headroom voltage is presented, the method comprising: realizing an input leg of the cascode current mirror by series-connecting a common-source composite transistor with a first common-gate intrinsic transistor; realizing an output leg of the cascode current mirror by series-connecting a first common-source transistor with a second common-gate intrinsic transistor; and biasing gates of the first and second common-gate transistors with a voltage at an intermediate node that connects two series-connected transistors of the common-source composite transistor, wherein a ratio between a width and a length of each transistor of the two series-connected transistors is twice a ratio between a width and a length of any one of the first common-source transistor, the first common-gate intrinsic transistor, or the second common-gate intrinsic transistor.

Further aspects of the disclosure are provided in the description, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows a simplified schematic of a cascode current mirror wherein gate voltages for transistors of the output leg are generated by the input leg.

FIG. 1B shows a simplified schematic of another cascode current mirror wherein gate voltages for transistors of the output leg are generated by the input leg.

FIG. 2 shows a simplified schematic of a cascode current mirror according to an embodiment of the present disclosure.

FIG. 3 shows a simplified schematic of a cascode current mirror according to an embodiment of the present disclosure, the casode current mirror including a plurality of output legs.

FIG. 4 shows a simplified schematic of a cascode current mirror according to another embodiment of the present disclosure, the cascode current mirror configured for a higher output voltage at the output leg.

FIG. 5 is a process chart showing various steps of a method according to an embodiment of the present disclosure for operating a cascode current mirror with low headroom voltage.

Like reference numbers and designations in the various drawings indicate like elements.

### DETAILED DESCRIPTION

Throughout the present disclosure, embodiments and variations are described for the purpose of illustrating uses and implementations of inventive concepts of various embodiments. The illustrative description should be understood as presenting examples of the inventive concept, rather than as limiting the scope of the concept as disclosed herein.

A cascode current mirror may increase its output resistance by inclusion of a cascode stack at an output leg of the current mirror. Because the cascode stack includes at least one common-gate (cascode) transistor in series connection (e.g., stacked) with a common-source (input) transistor, operation of the output leg may require a voltage headroom that is equal to the sum of the gate-to-source (Vgs) voltage of the common-source transistor and the overdrive voltage of the common-gate transistor, and therefore may be considered too large for operation with low voltage supplies (e.g., 1.2 volts and below) and/or too limiting with respect to a dynamic range (e.g., swing) of a voltage coupled to the output leg of the current mirror.

One possible design technique to overcome the above shortcoming of a cascode current mirror is through use of one or more dedicated transistor branches (different from the input leg) to generate one or more gate voltages for biasing one or more common-gate (cascode) transistors of the output leg of the current mirror. In this case, operation of the output leg may require a voltage headroom that is approximately equal to the sum of the overdrive voltages of the common-source and common-gate transistor, and therefore sufficiently low for operation with some low voltage supplies (e.g., 1.2 volts and below). However, this potential solution comes at a cost associated with at least one extra/dedicated transistor branch, including larger die area and higher power consumption, the cost increasing with a scaling up of the number of common-gate (cascode) transistors.

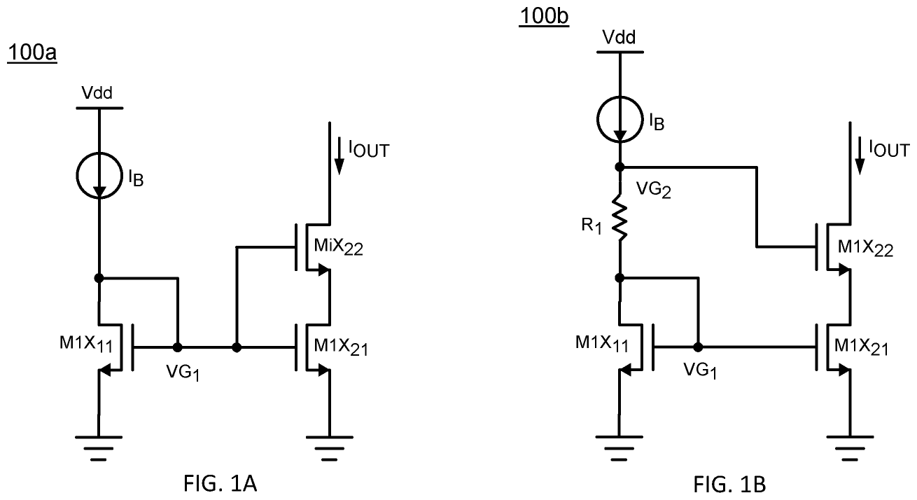

FIG. 1A shows a simplified schematic of a cascode current mirror (100a) including an input leg, (M1X₁₁, e.g., reference branch), comprising a common-source (FET) transistor, M1X₁₁, and an output leg (M1X₂₁, MiX₂₂, e.g., output branch) comprising a common-source (FET) transistor, M1X₂₁, in series connection with a common-gate (cascode) MiX₂₂. A (reference) current source, I_{B}, is coupled to the input leg (M1X₁₁). During operation, a current, I_{B}, that flows from the current source, I_{B}, through the input leg (M1X₁₁) is mirrored by the output leg (M1X₂₁, MiX₂₂) and output as an output (sink) current, I_{OUT}.

With continued reference to FIG. 1A, the transistor, M1X₁₁, of the input leg (M1X₁₁) is in a diode-connected configuration so as to self-bias for conduction of the input current, I_{B}, through such transistor. In other words, because the drain and gate of the transistor, M1X₁₁, are connected to one another, the gate voltage, VG₁, self-establishes for conduction of the input current, I_{B}, through the transistor, M1X₁₁, based for example, on current-voltage characteristics (e.g., I-V curves) of the transistor, M1X₁₁. In turn, the gate voltage, VG₁, is used to establish gate biasing voltages to the transistors M1X₂₁ and MiX₂₂ of the output leg (M1X₂₁, MiX₂₂) for conduction of the output current, I_{OUT}.

Use of a common gate voltage (e.g., VG₁) for biasing of both transistors, M1X₂₁ and MiX₂₂, of the output leg (M1X₂₁, MiX₂₂) is made possible by selection of such transistors to include a “regular” transistor (e.g., M1X₂₁) having a size, W/L, provided by a ratio of its width (W) to its length (L), and an “intrinsic” or “native” transistor (e.g., M1X₂₂) of a same size. As used in the present disclosure, a regular transistor is a transistor having (regular) positive threshold voltage (Vₜₕ), and an intrinsic transistor is a transistor having a (strictly) negative and non-zero Vₜₕ voltage, wherein the Vₜₕ voltage is a gate-to-source voltage that puts the transistor at a limit between conduction and non-conduction. The Vₜₕ of a regular NMOS FET transistor may be approximately (positive) 500 millivolts or greater, and the Vₜₕ of an intrinsic NMOS FET transistor may be approximately negative 200 millivolts or less (i.e., more negative). In some embodiments according to the present disclosure, the Vₜₕ of the intrinsic NMOS FET transistors may be in a range from negative 200 millivolts to negative 250 millivolts.

Accordingly, a regular transistor (e.g., M1X₂₁) may operate in a corresponding saturation region for a gate-to-source voltage, Vgs, of about 600 millivolts that is equal to the sum of the (positive) Vₜₕ voltage of the transistor (e.g., about 500 millivolts) and an overdrive volage, V_{OV}, of the transistor (e.g., as low as about 100 millivolts). On the other hand, an intrinsic transistor (e.g., M1X₂₂) may operate in a corresponding saturation region for a gate-to-source voltage, Vgs, that is equal to the sum of the (negative) Vₜₕ voltage of the transistor (e.g., about negative 200 millivolts or less) and an overdrive volage, V_{OV}, of the transistor (e.g., as low as about 100 millivolts). Accordingly, such intrinsic transistor may operate in its saturation region for a gate-to-source voltage, Vgs, that is substantially less than 600 millivolts, such as for example, less than 150 millivolts and potentially extending into a negative voltage (depending on the negative value of the Vₜₕ voltage). It is noted that a necessary condition for operation of a FET transistor in its saturation region (and therefore provision of a high output impedance of the transistor) is a drain-to-source voltage, Vds, that is greater than the overdrive volage, V_{OV}, of the transistor (i.e., Vds>Vgs−Vₜₕ). In other words, a FET transistor, either regular or intrinsic may operate in its saturation region for a Vds voltage that may be as low as about 100 millivolts.

With continued reference to FIG. 1A, the gate voltage, VG₁, represents the Vgs and the drain-to-source voltage (Vds) of the transistor M1X₁₁, as well as the Vgs of the transistor M1X₂₁. On the other hand, the Vds of the transistor M1X₂₁ is represented by a difference between the gate voltage, VG₁, which is the Vgs of the regular transistor M1X₁₁, and the Vgs of the intrinsic transistor M1X₂₂. Assuming that M1X₁₁ and M1X₂₂ operate at similar, or close, values of the corresponding overdrive voltages, V_{OV}, then the Vds of the transistor M1X₂₁ may be represented by a difference between the (positive) Vₜₕ of the (regular) transistor M1X₁₁ and the (negative) Vₜₕ of the (intrinsic) transistor M1X₁₁. In other words, although the (regular) transistors, M1X₁₁ and M1X₂₁, may have a same Vgs voltage, they have different Vds voltages, and therefore for a given gate voltage, VG₁, a current, I_{B}, that flows through the input leg (M1X₁₁) may be (slightly) different from a current, I_{OUT}, that flows through the output leg (M1X₂₁, MiX₂₂). Such difference between currents may in turn cause an undesired systematic offset of the cascode current mirror (100a).

Furthermore, since the Vds of the intrinsic transistor MiX₂₂ may be at least 100-150 millivolts and the Vds of the transistor M1X₂₁ may be larger than its Vₜₕ, then a headroom voltage required for operation of the output leg (M1X₂₁, MiX₂₂), in other words the sum of the Vds voltages of the transistors M1X₂₁ and MiX₂₂, may be larger than about 600-650 millivolts. Such relatively large headroom voltage required for operation of the output leg (M1X₂₁, MiX₂₂) may reduce available voltage swing (dynamic range) for a circuit coupled to the output leg (M1X₂₁, MiX₂₂).

FIG. 1B shows a simplified schematic of another cascode current mirror (100b) including an input leg, (M1X₁₁, R₁), comprising a common-source (FET) transistor, M1X₁₁, that is in series connection with a resistor, R₁, and an output leg (M1X₂₁, M1X₂₂) comprising a common-source (FET) transistor, M1X₂₁, in series connection with a common-gate (cascode) M1X₂₂. A (reference) current source, I_{B}, is coupled to the input leg (M1X₁₁). During operation, a current, I_{B}, that flows from the current source, I_{B}, through the input leg (M1X₁₁, R₁) is mirrored by the output leg (M1X₂₁, M1X₂₂) and output as an output (sink) current, I_{OUT}.

In contrast to the configuration (100a) described above with reference to FIG. 1A, the output leg (M1X₂₁, M1X₂₂) of the configuration (100b) of FIG. 1B does not include an intrinsic transistor as both transistors M1X₂₁ and M1X₂₂ are regular transistors (i.e., as opposed to intrinsic transistors). Similar to the configuration (100a), the gate voltage, VG₁, here used for biasing of the common-source transistor M1X₂₂ of the output leg (M1X₂₁, M1X₂₂), self-establishes for conduction of the input current, I_{B}, through the transistor, M1X₁₁, of the input leg (M1X₁₁, R₁). Furthermore, a voltage drop that is based on the conduction of the input current, I_{B}, through the resistor, R₁, establishes a gate voltage, VG₂, that is used for biasing of the common-gate (cascode) transistor M1X₂₂ of the output leg (M1X₂₁, M1X₂₂).

With continued reference to FIG. 1B, the resistor, R₁, may be selected to generate a gate voltage, VG₂, that is about one overdrive volage, V_{OV}, greater than the gate voltage, VG₁. In other words, the resistor, R₁, may be selected so that VG₂=Vₜₕ+2V_{OV}. Accordingly, since the Vgs of the transistor, M1X₂₂, may be approximated to Vₜₕ+V_{OV}, then the Vds of the transistor, M1X₂₁, may be approximated to V_{OV}. In other words, the configuration (100b) may allow a reduction of the headroom voltage required for operation of the output leg (e.g., M1X₂₁, M1X₂₂) when compared to the configuration (100a) of FIG. 1A. However, similarly to the configuration (100a), the configuration (100b) operates the common-source transistors, M1X₁₁ and M1X₂₁, at different Vds voltages which may lead to a systematic offset.

Furthermore, because the voltage drop across the resistor, R₁, has a linear dependence to the value of the current, I_{B}, and the voltage VG₁ (e.g., V_{OV} of transistor M1X₁₁) has a square root dependence to the value of the current, I_{B}, a variation in the current, I_{B}, may result in a shift of operating points of the transistors M1X₂₁ and M1X₂₂, such that, for example, the Vds voltages of the common-source transistors M1X₁₁ and M1X₂₁ may not track one another. In addition, process, voltage, and temperature (PVT) based variations may affect characteristics (e.g., resistance) of the resistor, R₁, differently from the characteristics (e.g., current-voltage) of the transistors used in the cascode current mirror (100b), thereby producing similar shifts of the operating points of the transistors M1X₂₁ and M1X₂₂, with similar effects. Finally, presence of a resistor (e.g., R₁) in a cascode current mirror may be undesirable due to its larger die area requirement, especially in low current applications where larger resistors may be required to generate a desired voltage drop across the resistor.

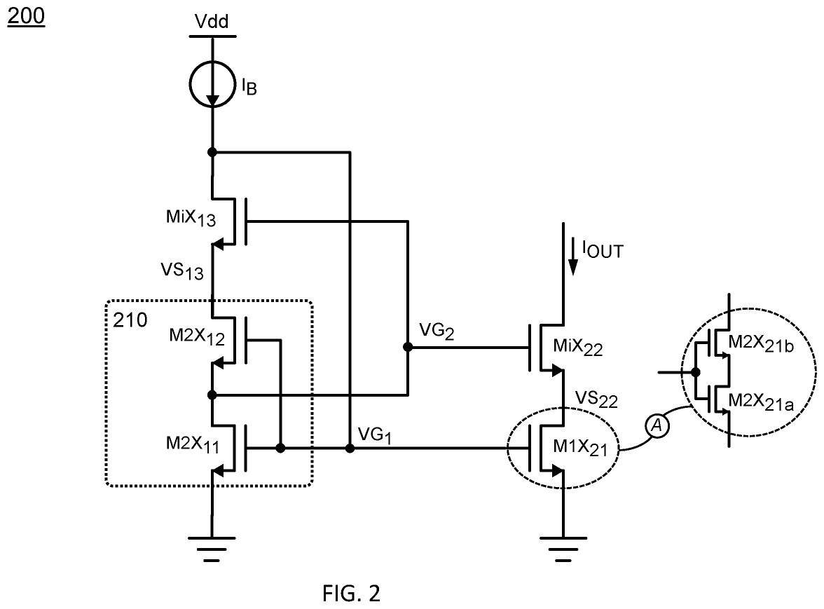

Teachings according to the present disclosure address design tradeoffs described above with reference to the configurations (100a) and (100b). In particular, FIG. 2 shows a simplified schematic of a cascode current mirror (200) according to an embodiment of the present disclosure. The cascode current mirror (200) includes an input leg, (210, MiX₁₃, e.g., reference branch), comprising series-connected transistors M2X₁₁, M2X₁₂, and MiX₁₃. A (reference) current source, I_{B}, is coupled to the input leg (210, MiX₁₃). During operation, a current, I_{B}, that flows from the current source, I_{B}, through the input leg (210, MiX₁₃) is mirrored by the output leg (M1X₂₁, MiX₂₂) and output as an output (sink) current, I_{OUT}.

With continued reference to FIG. 2, according to some embodiments of the present disclosure, the transistor MiX₁₃ of the input leg (210, MiX₁₃) and the transistor MiX₂₂ of the output leg (M1X₂₁, MiX₂₂) are intrinsic transistors. On the other hand, transistors M2X₁₁ and M2X₁₂ that make up element (210) of the input leg (210, MiX₁₃) and transistor M1X₂₁ of the output leg (M1X₂₁, MiX₂₂) are regular transistors. Furthermore, a size (e.g., 2×) of the transistors M2X₁₁ and M2X₁₂ is twice the size (e.g., 1×) of the transistors MiX₁₃, M1X₂₁, and MiX₂₂.

As shown in FIG. 2, the gates of the transistors M2X₁₁ and M2X₁₂ are connected to one another, and a drain of the transistor M2X₁₁ is connected to a source of the transistor M2X₁₂. Accordingly, the element (210) may be considered a composite transistor (210) having a source provided by a source of the transistor M2X₁₁, a drain provided by a drain of the transistor M2X₁₂, and a gate provided by the common gates (e.g., node carrying voltage VG₁) of the transistors M2X₁₁ and M2X₁₂. Furthermore, because the composite transistor (210) may include a width, W₂₁₀, that is equal to a width, W₂, of each of the transistors M2X₁₁ and M2X₁₂, and a length, L₂₁₀, that is the sum of the lengths, L₂+L₂, of the transistors M2X₁₁ and M2X₁₂, then the size, W₂₁₀/L₂₁₀, of the composite transistor (210) may be equal to W₂/(L₂+L₂), or in other words, equal to half the size (2×) of each of the transistors M2X₁₁ and M2X₁₂, which is equal to the size (1×) of each of the transistors, MiX₁₃, M1X₂₁, and MiX₂₂.

With continued reference to FIG. 2, the composite transistor (210) is in series connection with the (cascode) intrinsic transistor MiX₁₃. Similar to the configurations (100a, 100b) described above with reference to FIGS. 1A/1B, the gate voltage, VG₁, self-establishes for conduction of the input current, I_{B}, through the composite transistor (210) based on, for example, current-voltage characteristics (e.g., I-V curves) of the transistors M2X₁₁ and M2X₂₁. In turn, the gate voltage, VG₁, is used to bias the transistor M1X₂₁ of the output leg (M1X₂₁, MiX₂₂) for conduction of the output current, I_{OUT}. In other words, the Vgs voltage of the common-source composite transistor (210) of the input leg (210, MiX₁₃) is (e.g., exactly or nearly exactly) equal to the Vgs voltage of the common-source transistor M1X₂₁ of the output leg (M1X₂₁, MiX₂₂). Accordingly, since the transistors (210) and MIX₂₁ may be matched (e.g., same current-voltage characteristics and size), then for an equal value of the Vds voltages of such transistors (e.g., VS₁₃=VS₂₂), the current I_{OUT} through the transistor M1X₂₁ may be (e.g., exactly or nearly exactly) equal to the current I_{B} through the transistor (210).

As shown in FIG. 2, a voltage, VG₂, at an intermediate node between the two series-connected transistors M2X₁₁ and M2X₁₂, or in other words, a node that connects/couples a drain of the transistor M2X₁₁ to a source of the transistor M2X₁₂, is used as a gate voltage to bias the intrinsic transistors MiX₁₃ and MiX₂₂ of the input leg (210, M2X₁₁) and the output leg (M1X₂₁, MiX₂₂). Accordingly, since the transistors MiX₁₃ and MiX₂₂ may be matched (e.g., same current-voltage characteristics and size), then for an equal current to flow through such transistors (e.g., I_{B}=I_{OUT}), a same Vgs voltage establishes for both transistors, and therefore the voltage VS₁₃ becomes equal to the voltage VS₂₂ (e.g., VS₁₃=VS₂₂). In other words, the voltage, VG₂, establishes an equal value of the Vds voltages of the transistors (210) and M1X₂₁, and therefore, as described above, the current I_{OUT} through the transistor M1X₂₁ may be (e.g., exactly or nearly exactly) equal to the current I_{B} through the transistor (210).

Furthermore, because the transistor M1X₂₁ is intrinsic, and therefore includes a negative Vₜₕ, then the voltage VS₁₃, and therefore the Vds of the transistor (210) may be larger than the voltage VG₂, which may allow a sufficiently large and positive Vds voltage for operation of the transistors M2X₁₁ and M2X₁₂. For example, assuming that the voltage VG₂ is about positive 20-30 millivolts and the Vₜₕ of the intrinsic transistor about negative 220 millivolts, then the voltage VS₁₃, and therefore the Vds of the transistor (210), may be about positive 140-150 millivolts for an overdrive volage, V_{OV}, of about positive 100 millivolts. Accordingly, the Vds of the transistor M1X₂₁ of the output leg, which is equal to the Vds of the transistor (210) of the input leg, is also about positive 140-150 millivolts.

It follows that the configuration (200) of FIG. 2 allows for a lower headroom voltage of operation of the output leg (M1X₂₁, MiX₂₂) that is comparable, for example, to the headroom voltage described above with reference to the configuration (100b) of FIG. 1B, but without mismatch of the Vds voltages of the common-source transistors of the input/output legs. Furthermore, the input leg (210, M2X₁₁) of the configuration (200) includes a similarly low headroom voltage of operation that allows operation from a supply voltage, Vdd, that is as low as 1.2 volts or lower.

It is noted that use of the intrinsic transistors (MiX₁₃, MiX₂₂) as cascode transistors in the cascode current mirror (200) of FIG. 2 may be used for operation of said current mirror, which in turn allows use of a (low) voltage VG₂ at the intermediate node between the two series-connected transistors M2X₁₁ and M2X₁₂ for biasing of the cascode transistors, which in turn allows operation of each of the input and output legs at low headroom voltages that are about two times the overdrive voltage of the transistors (e.g., headroom voltages in a range from 200-250 millivolts).

According to some embodiments of the present disclosure, and as shown in detail A of FIG. 2, the common-source transistor M1X₂₁ of the output leg (M1X₂₁, MiX₂₂) may be a composite transistor that includes series-connected transistors M2X₂₁ₐ and M2X_{21b} that are respectively matched (e.g., in current-voltage characteristics and size) to the series-connected transistors M2X₁₁ and M2X₁₂ that make up the composite transistor (210) of the input leg (210, MiX₁₃). This in turn can allow for better overall matching of the two common-source (composite) transistors (210) and M1X₂₁.

With continued reference to FIG. 2, the transistors shown in FIG. 2 may be designed for operation according to desired/specific parameter values, including, for example, currents (e.g., I_{B} and I_{OUT}) and threshold/overdrive voltages. Such parameter values may further be in view of a required operation of the common-source transistors in their respective saturation regions. Relationships between (drain) current (I_{D}), threshold voltage (Vₜₕ), gate-to-source voltage (V_{gs}), overdrive voltage (Δ), transistor width (W), and transistor length (L) of a FET transistor are provided by the following (general) equations (1) and (2):

$${I}_{D} = \frac{{K}^{′}}{2} \frac{W}{L} {Δ}^{2} \qquad Equation ( 1 )$$

$$Δ = {V}_{g s} - {V}_{t h} = \sqrt{\frac{2 {I}_{D}}{{K}^{′} \frac{W}{L}}} \qquad Equation ( 2 )$$

wherein K and K′ are well established FET process parameters.
   Accordingly, applying the above equations to nodes carrying the voltages VG₁, VG₂, VS₁₃ and VS₂₂ shown in FIG. 2, the following equations (3), (4) and (5) are obtained:

$$V {G}_{1} = {V}_{th} + \sqrt{\frac{2 {I}_{B}}{{K}^{′} \frac{W}{L}}} \qquad Equation ( 3 )$$

$${VG}_{2} = {V}_{th} + \sqrt{\frac{2 {I}_{B}}{{K}^{′} \frac{W}{L}}} - ( {V}_{th} + \sqrt{\frac{2 {I}_{B}}{{K}^{′} \frac{W}{L}}} ) = ( 1 - \frac{1}{\sqrt{2}} ) Δ \qquad Equation ( 4 )$$

$${VS}_{13} = V {S}_{22} = V {G}_{2} - {V}_{g s i} = V {G}_{2} - ( {V}_{thi} + \sqrt{\frac{2 {I}_{B}}{{K}_{i}^{′} \frac{W}{L}}} ) = V {G}_{2} - ( {V}_{thi} + {Δ}_{i} ) \qquad Equation ( 5 )$$

wherein:
   Vₜₕ denoted the threshold voltage of the regular transistors,
   Δ denoted the overdrive voltage of the regular transistors,
   Vthi denoted the threshold voltage of the intrinsic transistors, and
   Vgsi denoted the gate-to-source voltage of the intrinsic transistors.

As previously described in the present application, some advantageous arrangements for maintaining a FET transistor in its saturation region of operation can be provided by: Vds>Vgs−Vₜₕ. According, since Vds=VS₁₃, and Vgs=VG₁, then, when applied to the above equations (1)-(5), the following inequality (6) is obtained:

$$( 1 - \frac{1}{\sqrt{2}} ) Δ - {V}_{t h i} - {Δ}_{i} > Δ ⇒ - \sqrt{2} ( {V}_{t h i} + {Δ}_{i} ) > Δ \qquad ( 6 )$$

which establishes a relationship between the overdrive voltage (Δ) of the regular transistors (e.g., M2X₁₁, M2X₁₂, M1X₂₁) and the overdrive voltage (Δᵢ) and threshold voltage (Vₜₕᵢ) of the intrinsic transistors (e.g., MiX₁₃, MiX₂₂), for operation of the cascode current mirror (200) of FIG. 2. In other words, by fabricating/designing the regular transistors (e.g., M2X₁₁, M2X₁₂, M1X₂₁) and the intrinsic transistors (e.g., MiX₁₃, MiX₂₂) to include threshold/overdrive voltages according to the inequality (6), operation of each of the transistors (210, MiX₁₃, M1X₂₁, MiX₂₂) in their respective saturation regions is expected. On the other hand, as clearly shown by equation (4), the voltage VG₂, which is equal to the Vds of the transistor M2X₁₁, is smaller than the overdrive voltage of such transistor. In other words, during operation of the cascode current mirror (200) of FIG. 2, the transistor M2X₁₁ operates in its triode region whereas all other transistors operate in their saturation region. It is noted that although the above equations are written in terms of the width, W, and the length, L, of the transistors (e.g., 1×/2× label prefixes indicating ratios of W to L), one may write the equations in terms of ratios and generalize for different sizes (e.g., scaling) of the transistors.

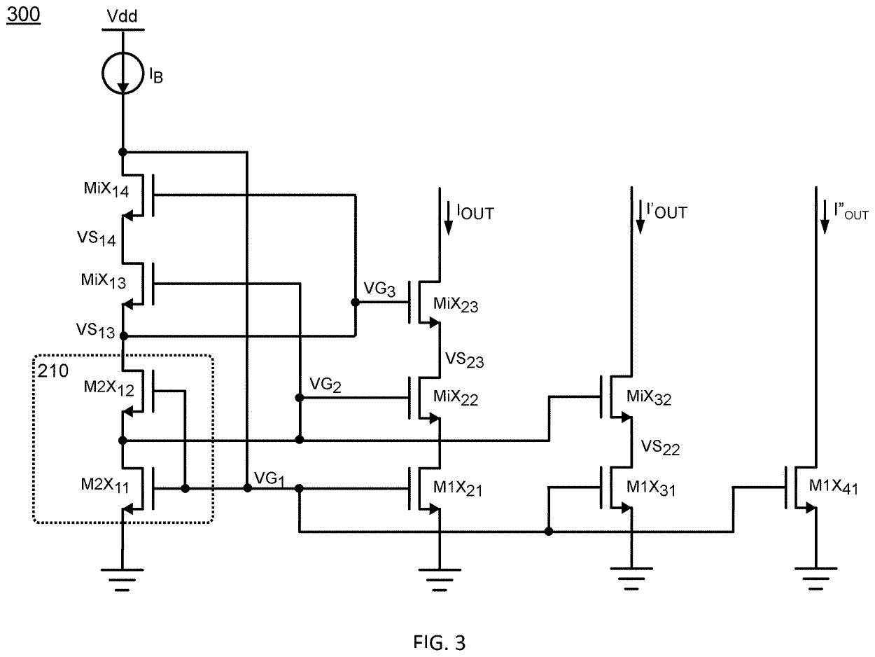

The configuration (200) described above with reference to FIG. 2 may be expanded for higher stacks in order to, for example, withstand higher voltages at the output leg and/or to increase output leg impedance. One such exemplary configuration is shown in FIG. 3.

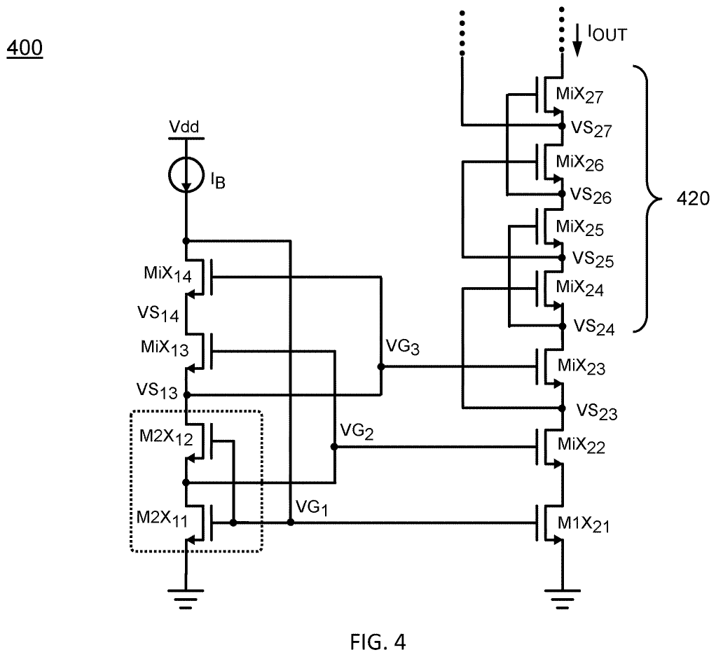

FIG. 3 shows a simplified schematic of a cascode current mirror (300) according to an embodiment of the present disclosure, the casode current mirror including a plurality of (parallel) output legs for outputting mirrored currents I_{OUT}, I′_{OUT} and I″_{OUT}. As shown in FIG. 3, a first output leg (M1X₂₁, MiX₂₂, MiX₂₂), that outputs the current I_{OUT}, includes a stacked cascode arrangement having a stack height of three, a second output leg (M1X₃₁, MiX₃₂), that outputs the current I′_{OUT}, includes a stacked cascode arrangement having a stack height of two, and a third output leg (M1X₄₁), that outputs the current I″_{OUT}, includes a single transistor. It is noted that the three output legs of the cascode current mirror (300) may operate independently from one another as their operation is solely based on gate biasing voltages (e.g., VG₁, VG₂, VG₃) generated by the input leg (210, MiX₁₃, MiX₁₄). Furthermore, configurations based on the configuration (300) of the FIG. 3 but without one or more of the shown output legs are possible (e.g., per FIG. 4 later described).

With continued reference to FIG. 3, principle of operation of the cascode current mirror (300) is similar to one described above with reference to FIG. 2, including use of the composite transistor (210) that includes transistors (M2X₁₁, M2X₂₁) having twice the size of the other transistors. Likewise, voltages at nodes VG₁, VG₂, VG₃, VS₁₃, VS₁₄, VS₂₂ and VS₂₃ shown in FIG. 3 may be obtained via the equations (1) and (2) as described above. In particular, the equations (3)-(5) and inequality (6) described above with reference to nodes shown in FIG. 2 may equally apply to same nodes shown in FIG. 3. In other words, similar to the configuration (200) of FIG. 2, all of the transistors of the configuration (300), at the exception of the transistor M2X₁₁, may operate in their respective regions of saturation. Because of the different stack heights of the three output legs (e.g., I_{OUT}, I′_{OUT}, I″_{OUT}) shown in FIG. 3, different output impedances, voltage swings and voltage withstand capabilities may be provided at the output legs.

According to some embodiments of the present disclosure, increased voltage withstand capability at an output leg (e.g, I_{OUT} of FIG. 3) may be provided via one or more series-connected transistors that are configured to self-bias. This is shown in FIG. 4, wherein a self-biased stack (420) of series-connected intrinsic transistors (MiX₂₄, . . . , MiX₂₇, . . . ) is coupled to the output leg (M1X₂₁, MiX₂₂, MiX₂₃). Accordingly, a (aggregate Vds, e.g., 100-150 millivolts per transistor) voltage drop across the self-biased stack (420) may allow for a higher voltage to couple to the output leg, including a voltage that is higher than a technology rating voltage (e.g., withstand voltage) of the transistors at the output leg. Because the stack (420) is self-biased, no additional biasing voltages may be generated by the input leg (210, MiX₁₃, MiX₁₄).

As shown in FIG. 4, self-biasing of a transistor of the series-connected intrinsic transistors (MiX₂₄, . . . , MiX₂₇, . . . ) may be provided by coupling a gate of the transistor to a source of an adjacent transistor whose drain is connected (e.g., directly coupled) to a source of the transistor. For example, considering the intrinsic transistor MiX₂₅ whose source is connected to the drain of the adjacent (intrinsic) transistor MiX₂₄, then self-biasing of the intrinsic transistor MiX₂₅ may be provided by connecting its gate to the source of the adjacent (intrinsic) transistor MiX₂₄. Because the self-biasing is provided by coupling the gates of the transistors to voltages that are smaller than voltages at the respective sources of the transistors, use of intrinsic transistors may be advantageous in some embodiments.

According to an exemplary embodiment of the present disclosure, the series-connected intrinsic transistors (MiX₂₄, . . . , MiX₂₇, . . . ) of the self-biased stack (420) may advantageously include source-body tied transistor devices that include bodies that are tied to the respective sources. Some advantages obtained by such source-body tied transistor device may include increased stability of the threshold voltage (Vₜₕ) of the device and therefore provide for a more stable self-biasing scheme.

It should be noted that teachings according to the present disclosure may not be limited to a cascode current mirror (e.g., FIGS. 3-4) having input/output legs configured to sink input/output currents via n-type FET transistor devices, rather, the present teachings equally apply to a cascode current mirror having input/output legs configured to source input/output currents via p-type FET transistor devices. Such p-type configuration may be considered a dual or complementary configuration to the n-type configuration described above.

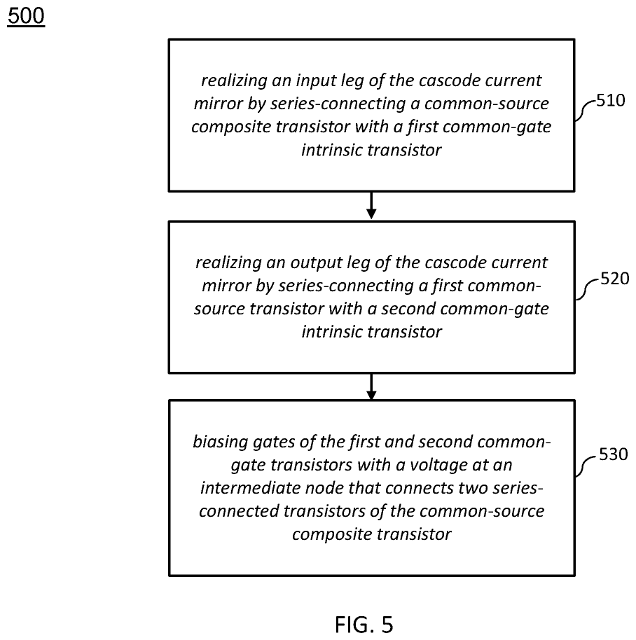

FIG. 5 is a process chart (500) showing various steps of a method for operating a cascode current mirror with low headroom voltage. As can be seen in the process chart (500), the method comprises: realizing an input leg of the cascode current mirror by series-connecting a common-source composite transistor with a first common-gate intrinsic transistor, per step (510), realizing an output leg of the cascode current mirror by series-connecting a first common-source transistor with a second common-gate intrinsic transistor, per step (520), and biasing gates of the first and second common-gate transistors with a voltage at an intermediate node that connects two series-connected transistors of the common-source composite transistor, per step (530), wherein a ratio between a width and a length of each transistor of the two series-connected transistors is twice a ratio between a width and a length of any one of the first common-source transistor, the first common-gate intrinsic transistor, or the second common-gate intrinsic transistor.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

The term “MOSFET” technically refers to metal-oxide-semiconductor-field-effect-transistor; another synonym for MOSFET is “MISFET”, for metal-insulator-semiconductor FET. However, “MOSFET” has become a common label for most types of insulated-gate FETs (“IGFETs”). Despite that, it is well known that the term “metal” in the names MOSFET and MISFET is now often a misnomer because the previously metal gate material is now often a layer of polysilicon (polycrystalline silicon). Similarly, the “oxide” in the name MOSFET can be a misnomer, as different dielectric materials are used with the aim of obtaining strong channels with smaller applied voltages. Accordingly, the term “MOSFET” as used herein is not to be read as literally limited to metal-oxide-semiconductor FETs, but instead includes IGFETs in general.

As should be readily apparent to one of ordinary skill in the art, various embodiments of the invention can be implemented to meet a wide variety of specifications. Unless otherwise noted above, selection of suitable component values is a matter of design choice and various embodiments of the invention may be implemented in any suitable IC technology (including but not limited to MOSFET and IGFET structures), or in hybrid or discrete circuit forms. Integrated circuit embodiments may be fabricated using any suitable substrates and processes, including but not limited to standard bulk silicon, silicon-on-insulator (SOI), silicon-on-sapphire (SOS), GaN HEMT, GaAs pHEMT, and MESFET technologies. However, the inventive concepts described above are particularly useful with an SOI-based fabrication process (including SOS), and with fabrication processes having similar characteristics. Fabrication in CMOS on SOI or SOS enables low power consumption, the ability to withstand high power signals during operation due to FET stacking, good linearity, and high frequency operation (in excess of about 10 GHZ, and particularly above about 20 GHz). Monolithic IC implementation is particularly useful since parasitic capacitances generally can be kept low (or at a minimum, kept uniform across all units, permitting them to be compensated) by careful design.

Voltage levels may be adjusted or voltage and/or logic signal polarities reversed depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functions without significantly altering the functionality of the disclosed circuits.

The examples set forth above are provided to give those of ordinary skill in the art a complete disclosure and description of how to make and use the embodiments of the gate drivers for stacked transistor amplifiers of the disclosure and are not intended to limit the scope of what the applicant considers to be the invention. Such embodiments may be, for example, used within mobile handsets for current communication systems (e.g., WCDMA, LTE, WiFi, etc.) wherein amplification of signals with frequency content of above 100 MHz and at power levels of above 50 mW may be required. The skilled person may find other suitable implementations of the presented embodiments.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications can be made without departing from the spirit and scope of the present disclosure. Accordingly, other embodiments are within the scope of the following claims.

1. A cascode current mirror circuit, comprising:
an input leg comprising a common-source composite transistor in series connection with a first common-gate intrinsic transistor; and
an output leg comprising a first common-source transistor in series connection with a second common-gate intrinsic transistor,
wherein
the composite transistor comprises two series-connected transistors with gates connected at a gate node of the common-source composite transistor, and
an intermediate node that connects the two series-connected transistors is connected to gates of the first and second common-gate intrinsic transistors.

2.-20. (canceled)
